(19) United States
(12) Patent Application Publication
(10) Pub. No.: US 2007/0181561 A1
(43) Pub. Date: Aug. 9, 2007

(54) Bottle heater

(75) Inventors: Thomas J. Turletes, Pawling, NY (US); Don R. Cornell, Pawling, NY (US)

Correspondence Address: SALTER & MICHAELSON;THE HERITAGE BUILDING, 321 SOUTH MAIN STREET, PROVIDENCE, RI, 029037128, US

(73) Assignee: Chemprene, Inc.

(21) Appl. No.: 11/350,210

(22) Filed: Feb. 8, 2006

(51) Int. Cl. H05B 3/34

(52) U.S. Cl. 219/528

(57) ABSTRACT

A bottle heater that includes a flexible band member having an inner heating surface adapted to be in contact with the bottle, a releasable retaining member for securing the flexible band member about the outer surface of the bottle and an electrical heating element disposed in the flexible band member for heating the flexible band member and extending over a heating element area. A first thermostat is disposed within the heating element area over the flexible band member for sensing and controlling the temperature of the electric heating element and a second thermostat is disposed within the heating element area spaced from and under the electrical heating element for sensing the temperature of the bottle.

### TECHNICAL FIELD

The present invention relates in general to a heating device for bottles or the like. More particularly, the present invention pertains to an electrical heating belt for liquid or gas filled bottles or containers, particularly propane bottles.

### BACKGROUND OF THE INVENTION

An electrical heating belt for propane bottles is known. One example is found in U.S. Pat. No. 4,912,303. Existing heating belts provide for thermostatic control, however, this control has not been sufficiently effective. This can cause excessive heating of the propane bottle or other container leading to an unsafe condition.

Accordingly, it is an object of the present invention to provide an improved belt-type heater that provides improved regulation of the heating of a bottle or other container.

Another object of the present invention is to provide an improved heating belt that preferably provides for multiple temperature sensors for the control of the heating of the container by sensing both container temperature and belt temperature.

### SUMMARY OF THE INVENTION

To accomplish the foregoing and other object, features and advantages of the present invention there is provided a bottle or container heater that comprises a flexible band member having an inner heating surface adapted to be in contact with the bottle; a releasable retaining member for securing the flexible band member about the outer surface of the bottle; an electrical heating element disposed in the flexible band member for heating the flexible band member and extending over a heating element area; a first thermostat disposed within the heating element area over the flexible band member for sensing and controlling the temperature of the electric heating element; and a second thermostat disposed within the heating element area spaced from and under the electrical heating element for sensing the temperature of the bottle.

In accordance with other aspects of the present invention there is provided a bottle heater wherein the flexible band member may comprise a pair of layers of a rubber material having the electrical heating element disposed therebetween; each layer of rubber material may also include an encased, inter-woven, reinforcing, fabric material and further including a third layer over the pair of layers and of a rubber material without a reinforcing fabric material; preferably including a protective cap over the first and second thermostats and wherein the electric heating element comprises a resistance heating wire disposed in a serpentine pattern covering the heating element area; each thermostat has a predetermined set point and the first thermostat has a higher set point than the set point of the second thermostat; preferably including a third thermostat disposed adjacent the first and second thermostats and disposed within the heating element area over the flexible band member for sensing and controlling the temperature of the electric heating element; and the set point of the third thermostat is higher than the set point of the first thermostat.

In accordance with another feature the bottle heater comprises a flexible belt having an electrical heating element imbedded therein, an inner heating surface adapted to be in contact with the bottle and means for securing the belt about the bottle; a first thermostat disposed within the heating element area over the flexible band member for sensing and controlling the temperature of the electric heating element; the first thermostat having a predetermined set point at which the thermostat opens to interrupt power to the heating element; a second thermostat disposed within the heating element area under the electrical heating element for sensing the temperature of the bottle; the second thermostat having a predetermined set point at which the thermostat opens to interrupt power to the heating element; and wherein the first thermostat has a higher set point than the set point of the second thermostat.

In accordance with further aspects of the present invention the flexible band member may comprise a pair of layers of a rubber material having the electrical heating element disposed therebetween, wherein each layer of rubber material also includes an inter-woven reinforcing fabric material and further including a third layer over the pair of layers and of a rubber material without a reinforcing fabric material and wherein the electric heating element comprises a resistance heating wire disposed in a serpentine pattern covering the heating element area; including preferably a third thermostat disposed adjacent the first and second thermostats and disposed within the heating element area over the flexible band member for sensing and controlling the temperature of the electric heating element; the set point of the third thermostat may be higher than the set point of the first thermostat; the set point of the third thermostat may be higher than the set point of the second thermostat; the set point of the first thermostat is on the order of 60° C., the set point of the second thermostat is on the order of 35° C. and the set point of the third thermostat is on the order of 65 degrees C.; and the second thermostat has a sensing port that is exposed to the temperature of the bottle.

In accordance with another feature the bottle heater comprises a flexible band member having an inner heating surface adapted to be in contact with the bottle; a releasable retaining member for securing the flexible band member about the outer surface of the bottle; an electrical heating element disposed in the flexible band member for heating the flexible band member and extending over a heating element area; at least a first thermostat disposed within the heating element area over the flexible band member for sensing and controlling the temperature of the electric heating element; and wherein the flexible band member comprises a pair of layers of a rubber material having the electrical heating element disposed therebetween.

In accordance with further aspects of the present invention a second thermostat may be disposed within the heating element area under the electrical heating element for sensing the temperature of the bottle; a third thermostat may be disposed adjacent the first and second thermostats and disposed within the heating element area over the flexible band member for sensing and controlling the temperature of the electric heating element; the second thermostat may have a sensing port that is exposed to the temperature of the bottle; each layer of rubber material also may include an inter-woven reinforcing fabric material and further including a third layer over the pair of layers and of a rubber material without a reinforcing fabric material and preferably including a protective cap over the first and second thermostats and wherein the electric heating element comprises a resistance heating wire disposed in a serpentine pattern covering the heating element area.

### DESCRIPTION OF THE DRAWINGS

Numerous other objects, features and advantages of the present invention should now become apparent upon a reading of the following detailed description taken in conjunction with the accompanying drawings, in which:

FIG. 1 is a perspective view showing the heater belt of the present invention as secured about a propane bottle;

FIG. 2 is a plan view of the heating belt, apart from the bottle;

FIG. 3 is a fragmentary plan view at the end of the flexible belt where electrical power is coupled;

FIG. 4 is a side elevation view of the flexible heating belt;

FIG. 5 is an enlarged fragmentary view showing further details at the protective cap;

FIG. 6 is a cross-sectional view through the heating belt at the protective cap;

FIG. 7 is a fragmentary exploded view showing the components of the heating belt;

FIG. 8 is a schematic diagram of the electric circuit used with the heating belt; and

FIG. 9 is a fragmentary cross-sectional view of a preferred arrangement of the operating thermostat for sensing and regulating container temperature.

### DETAILED DESCRIPTION

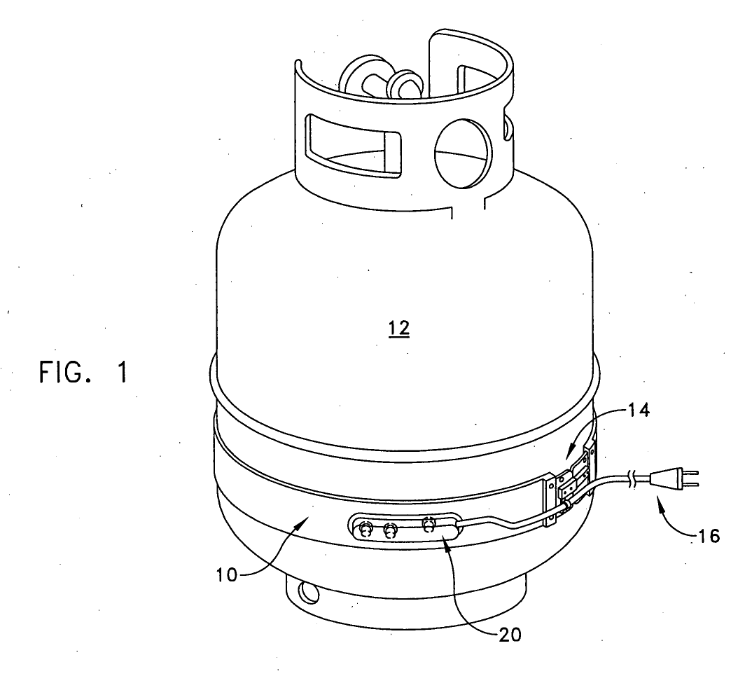

Reference is now made to FIG. 1 which is a perspective view illustrating the flexible heating belt 10 as secured about a conventional propane bottle 12. Means are provided for securing the opposite ends of the belt tightly about the outer circumference of the bottle 12. This securing means is shown in FIG. 1 at 14. The securing means 14 may comprise a conventional fastener or clip arrangement that secures the ends of the belt together and at the same time secures the belt tightly about the cylindrical bottle. FIG. 1 also shows the power cord 16 that is used to couple electrical energy to the flexible heating belt. The cord 16 is illustrated in FIG. 1 as coupling to the protective cap 20. The protective cap 20 houses the thermostats that are described in detail later. The electrical power that is coupled to the heating belt may be either AC or DC power and preferably is the conventional 110 volt AC line. Alternatively, the power can be 230 volt AC common in Europe.

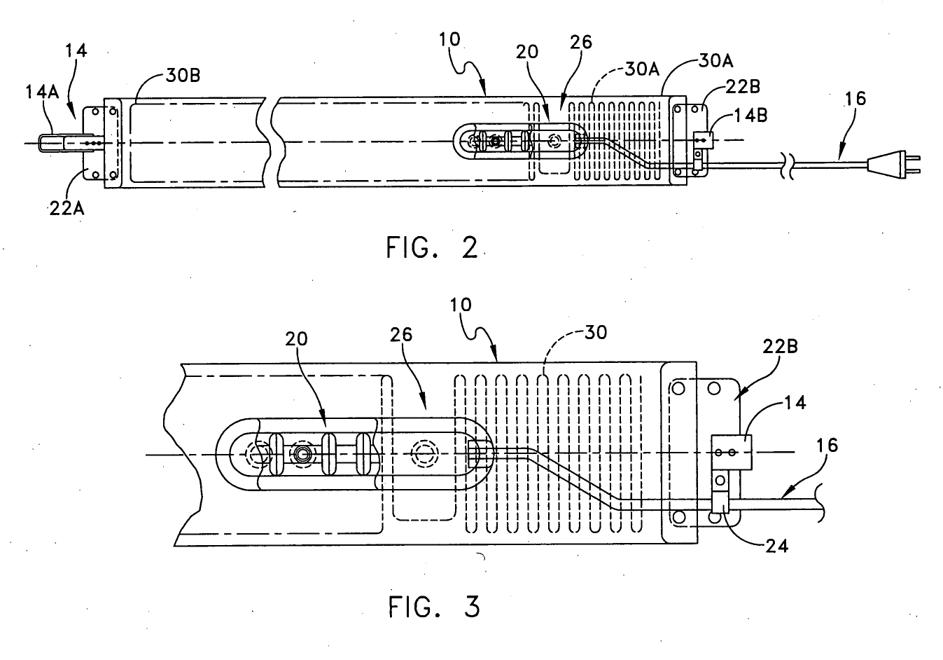

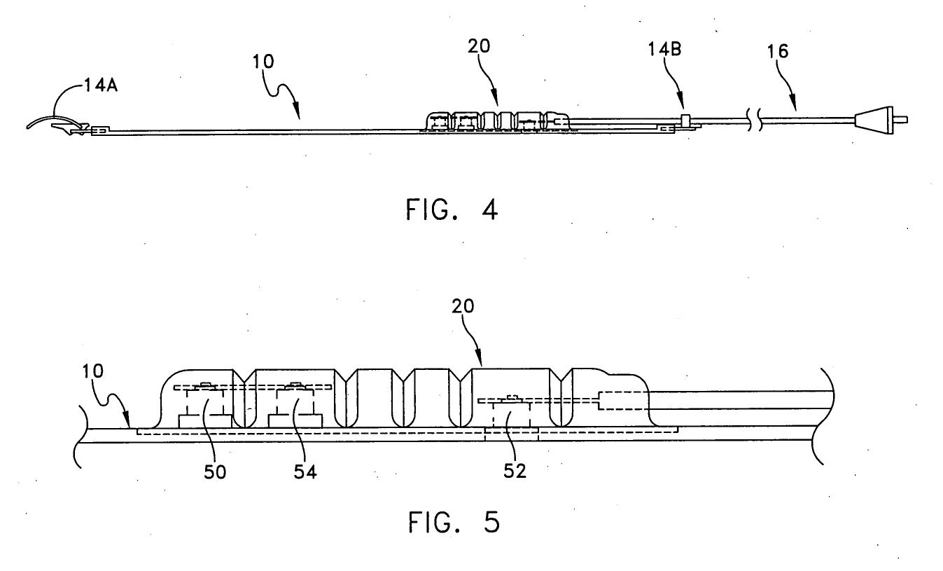

FIGS. 2 and 3 provide some further details of the belt construction. This belt is of a sufficient length to fit about the cylinder and may be provided in a width of approximately 5.0 inches and a length of approximately 36 inches. There are supports at both ends of the belt, shown in FIG. 2 as the end plates 22A and 22B. These end plates may be secured by appropriate means to ends of the layers that comprise the belt 10. For example, these may be secured by screws or rivets, or may be integrally molded into the belt structure. FIG. 2 also illustrates the separate components that comprise the securing means 14. These are described as interlocking elements 14A and 14B. These elements 14A and 14B together provide a clasping arrangement for tightly securing the belt about the cylindrical container. The end plate 22B may also include a small holder or clip 24 for holding the electrical cord in place at the location where the cord joins the belt. The clip 24 also relieves the stress from the cap 20.

The electrical heating belt or band 10 is also illustrated in FIGS. 2 and 3, by dotted outline, as including the heating element 30 that extends substantially the entire length of the belt 10 from one end 30A to another end 30B. In the preferred embodiment the heating element is a wire disposed in a serpentine configuration, as illustrated. This serpentine or sinusoidal pattern is interrupted as indicated at 26 at a location where one of the thermostats is disposed, to be discussed in further detail hereinafter. This interruption provides a short space where the belt is substantially free of the heating element, although the heating element does maintain its electrical continuity. A protective cap 20 of somewhat elongated shape is disposed over the thermostat array and is sealed with the top layer forming the heating belt 10.

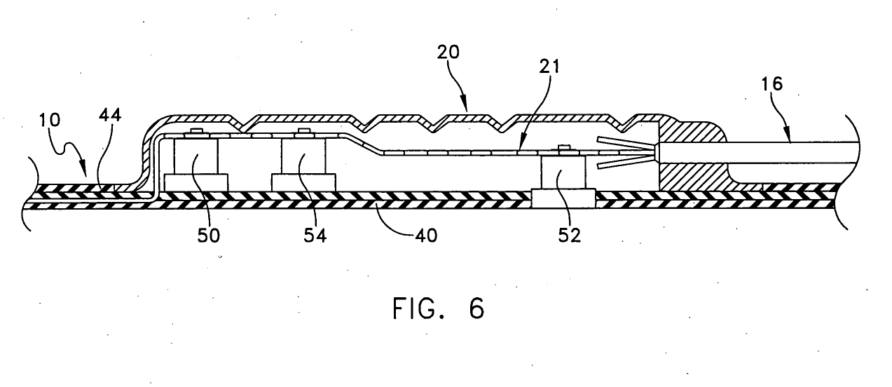

The electrical heating belt 10 may be considered as being formed in three layers identified as layers 40 and 42 of one type and an overlying layer 44 of another type. These various layers are illustrated in the cross-sectional view of FIG. 6. FIG. 6 also illustrates the array of thermostats including thermostats 50, 52 and 54.

The body of the belt 40, which is comprised of layers 40, 42 and 44, may be molded under heat and pressure with layers 40 and 42 formed of a synthetic rubber compound such as EPDM. This particular synthetic rubber compound is formulated to be flame resistant per Underwriters Laboratories Specification “UL 94 V-0”. Each of these layers also incorporate a reinforcing fabric. The EPDM compound is quite desirable for outdoor applications due to its tough physical properties and resistance to ultraviolet deterioration. The reinforcing fabric, formed as part of each layer is of woven construction and provides overall strength and durability to the product as well as providing for electrical insulation and separation of the heating element.

The aforementioned EPDM is ethylene propylene diene monomer; a type of synthetic rubber that is used for outdoor applications due to its good weather resistance, ozone resistance, good physical properties and heat resistance. The base elastomer (EPDM) may be used with fillers, carbon black, process oils, etc. to achieve the desired properties. A small amount of silicone may also be added to increase the weather resistance and to enhance other physical properties. Ingredients may also be added to make it flame retardant to UL 94 V-0 standards.

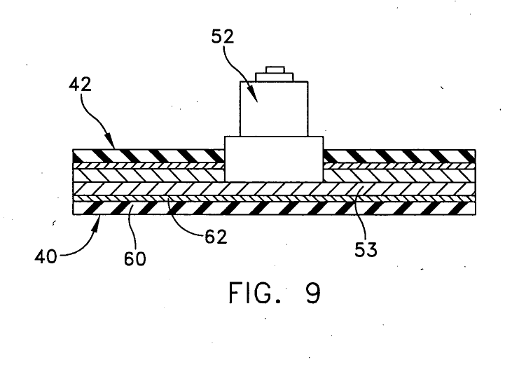

The layers 40 and 42 may be constructed from a single layer that is folded on itself and about the heating element 30. This layer, as indicated before, is formed of a synthetic rubber material that encases a reinforcing woven fabric material. Refer to FIG. 9 for a further detail of the construction. The rubber material portion of the layer, in each layer, is shown at 60 and the fabric portion at 62. The woven fabric material (layer) has the rubber material calendared on both sides to form a sandwich arrangement with a total thickness of approximately 0.030 inch.

The heating element 30 is preferably integrally molded between the layers 40 and 42 so as to be in relatively close proximity to the tank side, than to the ambient environment side so as to promote efficient energy transfer into the tank, while thermally insulating the environment side. In the drawings the heating element is shown somewhat schematically and as being disposed in a serpentine pattern. The heating element itself may be constructed as a resistance heating wire with characteristics that define its overall length, and therefore total resistance, and its heat density. The resistance wire is shaped into a sinusoidal wave pattern with predetermined controlled distances between the wave peaks which determines the optimum heat density and, indirectly, the watt density. In an alternate embodiment the heating element may be one other than a wire element, such as a heating blanket.

By controlling the resistance and density of the heating element wire, the apparatus is adapted to operate on virtually any common voltage input. For example, the heating band or belt can be operated off of 12 volts DC as with a car battery, with a 110 volts AC as in a standard U.S. house outlet, or at 230 volts AC as in standard European household outlets. The apparatus is preferably adapted for operation at approximately 500 watts to accommodate most usage conditions. To provide enhanced efficiency, the belt construction is adapted to cover as much of the tanks circumference as possible, preferably 85 percent or more. It is also preferred that the belt be located at a relatively low location on the tank, such as is illustrated in FIG. 1.

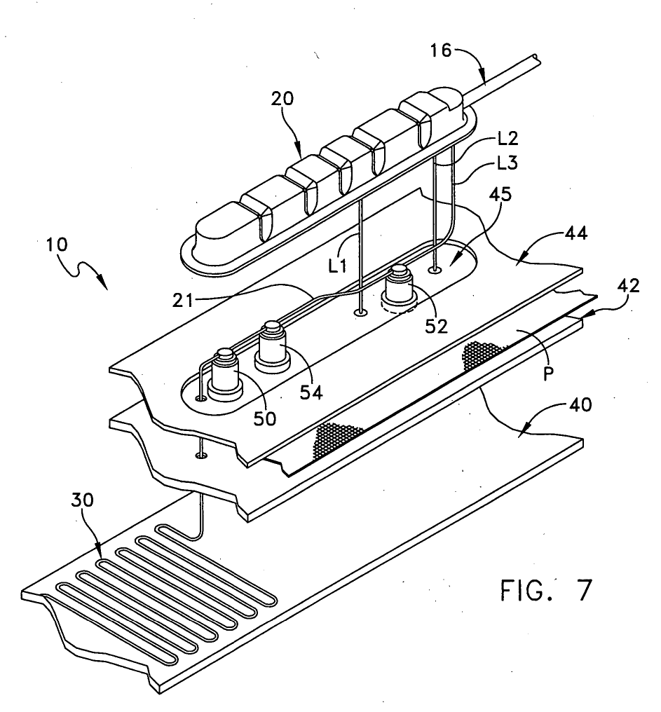

FIGS. 6 and 7 provide further details of the cap 20 and the multiple layers 40, 42 and 44. As indicated previously, these layers 40 and 42 include a reinforcing fabric of a woven construction to enhance strength and durability of the heater construction. There is also preferably a third layer 44 that is provided without the reinforcing fabric and is thus constructed of a rubber material such as the synthetic rubber compound EPDM. An aperture 45 is provided in the layer 44 and is sized to accommodate the cap 20. The cap 20 is separately molded from the same synthetic rubber as used for the layers but without any fabric reinforcement. The cap 20 is preferably molded into a rigid structure. Once the wiring connections are made to the thermostats within the cap 20, the cap 20 may then be joined to the body of the heater with an adhesive. The adhesive is applied about the peripheral edge of the cap 20. In this way the cap and the heater body are completely sealed against weather intrusion to IPX-6 standards which allows for its safe use outdoors. The adhesive that is used for bonding the cap to the layers is preferably a waterproof and heat proof flexible adhesive. With the use of the recess 45 the cap is located within the recess and essentially molded into the body to provide a flush appearance, as illustrated in FIG. 6.

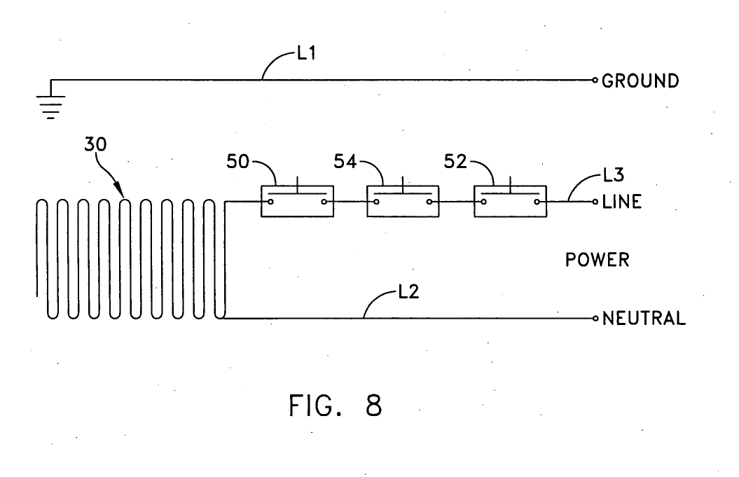

FIGS. 6 and 7 also illustrate the wiring 21 as well as a portion of the power cord 16. The power cord may be a three-wire cord set that is grounded, as illustrated. A bus bar layer may be provided between the layer 42 and the layer 44. This may be in a grid pattern. Refer to FIG. 7 and the ground plane P which may be a metal mesh or screen that covers the length and width of the heating element area. In FIGS. 7 and 8 also see the ground line L1, neutral line L2 and main line L3. In addition, all joints between the cord, the cap and the heater components are sealed with an adhesive to IPX-6 standards.

As indicated previously, and depicted in, for example, FIG. 2, the heating element extends virtually from one end of the belt construction to the other. Only a portion of the heating element 30 is depicted in FIG. 7. For a diagram of the manner in which the thermostats 50, 52 and 54 are connected with the heating element, refer to FIG. 8. This illustrates the use of a series circuit in which each of the thermostats is connected in series with the resistance heating wires of element 30. This series circuit is connected across a power line which may be either an AC or DC line. FIG. 3 also illustrates the area where there is a gap between heater coils associated with the position where thermostat 52 is disposed.
The thermostat array is all disposed within the cap 20 and is furthermore disposed in a rather compact arrangement in which the three thermostats can be provided in relatively close proximity to each other. Of the three thermostats that are used, namely thermostats 50, 52 and 54, the thermostats 50 and 52 are considered as main operating thermostats. All of the thermostats that are shown are in a normally closed position and open or switch off at the preset temperature thereof. The thermostat 50 is preferably preset to switch off at 60 degrees C. This thermostat is located over the heated portion of the heating belt. This is illustrated in FIG. 6 wherein thermostat 50 is disposed within the cap 20 and in contact with the upper surface of the layer 42. As indicated previously, the heating element 30 is disposed between layers 40 and 42. A portion of the heating element 30 may be under and in relatively close proximity to the thermostat 50. The function of the thermostat 50 is to regulate the heating element temperature, and thus the temperature of the belt.
Thermostat 52 is the second operating thermostat and is preferably preset to switch off at 35° C. As noted from FIG. 6, this thermostat is not disposed over the heating layers 40 and 42 but instead is disposed for contact, or near contact with the surface of the bottle that is being heated. The main purpose of the thermostat 52 is to sense the temperature of the bottle surface.

The interaction between the heater and the cylinder is somewhat complicated due to changing liquid levels within the cylinder, the ambient temperature, the rate at which the gas is removed from the cylinder, and other factors. Thus, it is preferred in accordance with the present invention to provide this additional operating thermostat 52 so that the cylinder would not become overheated, regardless of what the actual heating temperature is. The two thermostats 50, 52 in conjunction, regulate the operation of the heater under normal operating conditions. They are located in relatively close proximity to one another as is convenient in the fabrication of the heater apparatus.

The third thermostat 54 may be considered as an upper limit thermostat. The thermostat 54 is provided with a preset that will switch off at 65° C., which is slightly above the 60° C. preset of the operating thermostat 50. This thermostat is a failsafe mechanism that will interrupt power if there is a fault in the system or if the heater does not make good contact with the cylinder. This thermostat, as noted from FIG. 6 is in close proximity to the other two thermostats and is essentially disposed between the thermostats 50 and 52. The thermostat 54 is also located over the heated portion of the belt.

The thermostat arrangement of the present invention is instrumental in providing improved temperature control. For example, if thermostat 52 fails thermostat 50 takes over and still limits the bottle temperature so that it should not exceed about 45 degrees C. This ensures additional safety of operation of the heating belt. If both thermostats 50 and 52 fail then the thermostat 54 will prevent overheating.

In FIG. 6 it is noted that the thermostat 52 is provided within a hole in the layers 40 and 42. This would provide direct contact of the thermostat 52 with the surface of the bottle. In a preferred embodiment, however, as illustrated in FIG. 9, the thermostat 52 is adapted to fit within a molded recess that leaves a relatively thin surface 53 between the thermostat and the bottle. The thin surface 53, which forms a part of the layer 40, may have a thickness on the order of 0.030 inch. Moreover, the thermostat 52 is preferably disposed at least ¾ inch from the closest loop of the heating element wire. Again, reference to FIG. 3 indicates the spacing of the thermostat from heating coils at 26.

Having now described a limited number of embodiments of the present invention it should be apparent to those skilled in the art that numerous other embodiments and modifications thereof are contemplated as falling within the scope of the present invention, as defined by the appended claims.

What is claimed is:

1. A bottle heater comprising:
a flexible band member having an inner heating surface adapted to be in contact with the bottle;
a releasable retaining member for securing the flexible band member about the outer surface of the bottle;
an electrical heating element disposed in the flexible band member for heating the flexible band member and extending over a heating element area;
a first thermostat disposed within the heating element area over the flexible band member for sensing and controlling the temperature of the electric heating element; and
a second thermostat disposed within the heating element area spaced from and under the electrical heating element for sensing the temperature of the bottle.

2. The bottle heater of claim 1 wherein said flexible band member comprises a pair of layers of a rubber material having the electrical heating element disposed therebetween.

3. The bottle heater of claim 2 wherein each layer of rubber material also includes an inter-woven reinforcing fabric material encased by said rubber material and further including a third layer over the pair of layers and of a rubber material without a reinforcing fabric material.

4. The bottle heater of claim 1 including a protective cap over said first and second thermostats and wherein the electric heating element comprises a resistance heating wire disposed in a serpentine pattern covering the heating element area.

5. The bottle heater of claim 1 wherein each thermostat has a predetermined set point and the first thermostat has a higher set point than the set point of the second thermostat.

6. The bottle heater of claim 5 including a third thermostat disposed adjacent the first and second thermostats and disposed within the heating element area over the flexible band member for sensing and controlling the temperature of the electric heating element.

7. The bottle heater of claim 6 wherein the set point of the third thermostat is higher than the set point of the first thermostat.

8. A bottle heater comprising:
a flexible belt having an electrical heating element imbedded therein, an inner heating surface adapted to be in contact with the bottle and means for securing the belt about the bottle;
a first thermostat disposed within the heating element area over the flexible band member for sensing and controlling the temperature of the electric heating element;
said first thermostat having a predetermined set point at which the thermostat opens to interrupt power to the heating element;
a second thermostat disposed within the heating element area under the electrical heating element for sensing the temperature of the bottle;
said second thermostat having a predetermined set point at which the thermostat opens to interrupt power to the heating element; and
wherein the first thermostat has a higher set point than the set point of the second thermostat.

9. The bottle heater of claim 8 wherein said flexible band member comprises a pair of layers of a rubber material having the electrical heating element disposed therebetween, wherein each layer of rubber material also includes an inter-woven reinforcing fabric material and further including a third layer over the pair of layers and of a rubber material without a reinforcing fabric material and wherein the electric heating element comprises a resistance heating wire disposed in a serpentine pattern covering the heating element area.

10. The bottle heater of claim 8 including a third thermostat disposed adjacent the first and second thermostats and disposed within the heating element area over the flexible band member for sensing and controlling the temperature of the electric heating element.

11. The bottle heater of claim 10 wherein the set point of the third thermostat is higher than the set point of the first thermostat.

12. The bottle heater of claim 11 wherein the set point of the third thermostat is higher than the set point of the second thermostat.

13. The bottle heater of claim 12 wherein the set point of the first thermostat is on the order of 60 degree C., the set point of the second thermostat is on the order of 35 degrees C. and the set point of the third thermostat is on the order of 65 degrees C.

14. The bottle heater of claim 8 wherein the second thermostat has a sensing port that is exposed to the temperature of the bottle.

15. A bottle heater comprising:
a flexible band member having an inner heating surface adapted to be in contact with the bottle;
a releasable retaining member for securing the flexible band member about the outer surface of the bottle;
an electrical heating element disposed in the flexible band member for heating the flexible band member and extending over a heating element area;
at least a first thermostat disposed within the heating element area over the flexible band member for sensing and controlling the temperature of the electric heating element; and
wherein said flexible band member comprises a pair of layers of a rubber material having the electrical heating element disposed therebetween.

16. The bottle heater of claim 15 including a second thermostat disposed within the heating element area under and spaced from the electrical heating element for sensing the temperature of the bottle.

17. The bottle heater of claim 16 including a third thermostat disposed adjacent the first and second thermostats and disposed within the heating element area over the flexible band member for sensing and controlling the temperature of the electric heating element.

18. The bottle heater of claim 17 wherein the second thermostat has a sensing port that is exposed to the temperature of the bottle.

19. The bottle heater of claim 15 wherein each layer of rubber material also includes an inter-woven reinforcing fabric material and further including a third layer over the pair of layers and of a rubber material without a reinforcing fabric material.

20. The bottle heater of claim 16 including a protective cap over said first and second thermostats and wherein the electric heating element comprises a resistance heating wire disposed in a serpentine pattern covering the heating element area.
